(19) United States
(12) Patent Application Publication
(10) Pub. No.: US 2025/0302696 A1
(43) Pub. Date: Oct. 2, 2025

(54) ADDITIVE SYRINGE

(71) Applicants: Gary Eves, Lavalette, WV (US); Christopher Grose, Glenwood, WV (US)

(72) Inventors: Gary Eves, Lavalette, WV (US); Christopher Grose, Glenwood, WV (US)

(21) Appl. No.: 19/096,471

(22) Filed: Mar. 31, 2025

Related U.S. Application Data
(60) Provisional application No. 63/572,313, filed on Mar. 31, 2024.

(51) Int. Cl. A61J 1/20; A61J 1/22

(52) U.S. Cl. CPC A61J 1/2093; A61J 1/22

(57) ABSTRACT

An additive syringe includes a housing and an adjustable actuator, the housing and actuatory mutually coupled, the housing having a surface gutter and the actuator having a surface key, the housing having a larger diameter than the actuator, and the housing having a plunger, the actuator having a needle supported by a chamber, the chamber aligning the needle with the plunger, and a dock formed in the housing or the actuator, the dock retaining a medicinal cartridge and aligning with the needle via the plunger to provide a metered quantity of buffering agent to the contents of the medicinal cartridge.

### RELATED APPLICATIONS

This application claims the benefit of U.S. Provisional Application No. 63/572,313, filed on Mar. 31, 2024.

### FIELD OF THE INVENTION

The present application discloses and describes an additive syringe, and in particular, a single-use additive syringe for distributing fluid to another vessel such as a cartridge.

### BACKGROUND OF THE INVENTION

Numerous attempts have been made to improve syringe utilization, especially at table or patient side. In particular, dental clinicians face increasing challenges with providing services that impart as little pain and discomfort as possible. The use of various injectable anesthetics, such as lidocaine, novacaine, and other related agents, provide reliable numbing effect. However, the level of pain associated with the injection and delivery of such an agent introduces a significant challenge toward this goal.

Buffering such anesthetic agents improves patient experience by reducing the pain associated with the injection and administration. Other additional positive effects include better immediate effects, reduction of waste among the various agents and buffers, and improved safety. Accordingly, a need exists for an improved delivery of anesthetic agents via syringe.

### SUMMARY OF THE INVENTION

In one embodiment, an additive syringe comprises a housing and an adjustable actuator, the housing and actuatory mutually coupled, the housing having a surface gutter and the actuator having a surface key, wherein the surface key is positionable within the surface gutter, and the surface key and the surface gutter producing an audible and tactile response when the surface key is positioned within the surface gutter, the housing having a larger diameter than the actuator, wherein the housing accommodates the actuator therein, and the housing having a plunger, the actuator having a needle supported by a chamber, the chamber aligning the needle with the plunger, and a dock formed in the housing or the actuator, the dock retaining a medicinal cartridge and aligning with the needle via the plunger to provide a metered quantity of buffering agent to the contents of the medicinal cartridge.

### BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a perspective view of a single-use additive syringe;

FIG. 2 is a perspective view of a single-use additive syringe;

FIG. 3 is a partial sectional view of the syringe taken along the line III-III in FIG. 1;

FIG. 4 is a partial sectional view of the syringe taken along the line IV-IV in FIG. 2;

FIG. 5 is a sectional view of the syringe taken along the line V-V in FIG. 4;

FIG. 6 is a side-view of the syringe;

FIG. 7 is a side-view of the syringe approximately 90 degrees disposed relative to FIG. 6;

FIG. 8a is a front view of the syringe in an opened position;

FIG. 8b is a sectional view of the syringe of FIG. 8a taken along line VIIIb-VIIIb;

FIG. 9a is a front view of the syringe in a closed position;

FIG. 9b is a sectional view of the syringe of FIG. 9a taken along line IXb-IXb;

FIG. 10a is an exploded perspective of another embodiment of an additive syringe;

FIG. 10b is an exploded perspective of FIG. 10a;

FIG. 11a and FIG. 11b are opposing perspective views of the additive syringe of FIG. 10a and FIG. 10b;

FIGS. 12a, 12b, and 12c are various front views of the additive syring of FIG. 11a and FIG. 11b;

FIG. 13a is a front view of the additive syringe of FIGS. 11a, 11b, 12a-12c;

FIG. 13b is a sectional view of the additive syring of FIG. 13a;

FIG. 14a is a front view of the additive syringe of FIGS. 11a, 11b, 12a-12c, the syringe in a first position;

FIG. 14b is a sectional view of the additive syring of FIG. 14a;

FIG. 15a is a front view of the additive syringe of FIGS. 11a, 11b, 12a-12c, the syringe in a second position;

FIG. 15b is a sectional view of the additive syring of FIG. 154a;

FIG. 16a is a front view of the additive syringe of FIGS. 11a, 11b, 12a-12c, the syringe in a third position;

FIG. 16b is a sectional view of the additive syring of FIG. 16a;

FIG. 17a through 17f are various perspective and front or sectional views of another embodiment of an additive syringe.

### DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

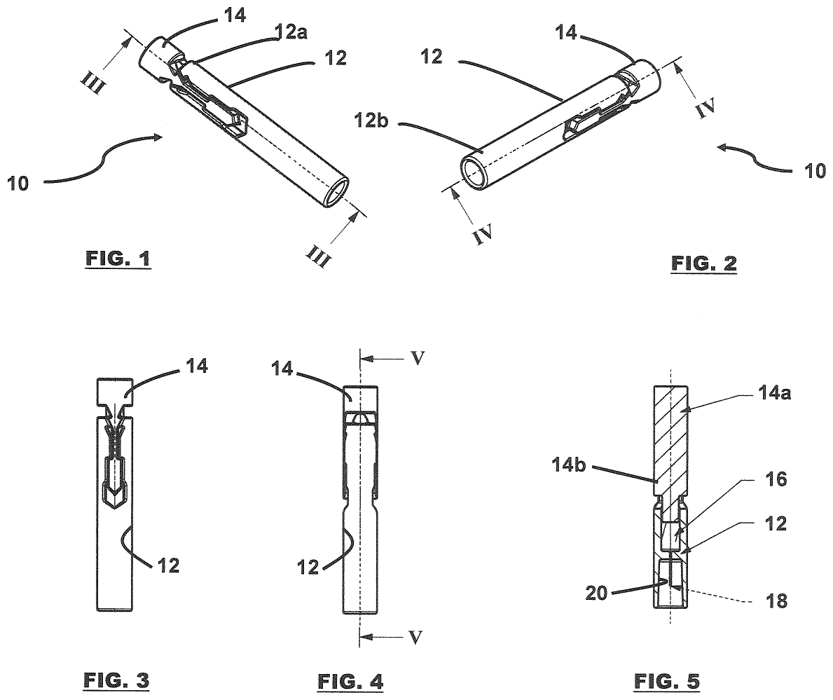

According to at least one embodiment, and consistent with FIG. 1 through FIG. 9b, a single-use additive syringe may be generally denoted by reference character 10. The syringe 10 delivers small doses of a liquid concentrate to medical grade medicinal cartidge or medicinal cartidges or carpules, like those used to deliver anesthetic in general dentistry and medicine. In particular, it is envisioned that the syringe 10 is suitably appropriate for medicinal cartidge or medicinal cartidges or carpules having a volume of approximately 1.7 mL to 1.8 mL, as well as the auto injector medicinal cartidge or medicinal cartidges or carpules possessing a volume of approximately 3.0 mL. The syringe 10 injects additive liquid such as sodium bicarbonate, or similar buffering agent to promote an optimal pH level. In a preferred embodiment, the volume of the additive liquid (e.g., buffering agent) may be provided in a range between 0.05 mL and 0.5 mL.

In particular, the syringe 10 comprises a housing 12 that accommodates an actuator 14 having a plunger 16 and in mechanical communication with a needle 18. The syringe 10 includes a dock 20 for accepting or receiving the medicinal cartidge or carpule therein and operates as a guide for assisting in coupling the needle 18 with medicinal cartidge or carpule as urged by the actuator 14 and plunger 16 assembly. The housing 12 and the actuator 14 may be manufactured from a variety of materials, although it is preferred to consider either polyethylene or polypropylene and/or a combination of the two. The needle 18 may comprise a variety of metals, although it is preferred that stainless steel is utilized. The plunger 16 may comprise a variety of materials, although it is preferred that silicone rubber or other similar polymer(s) might be useful.

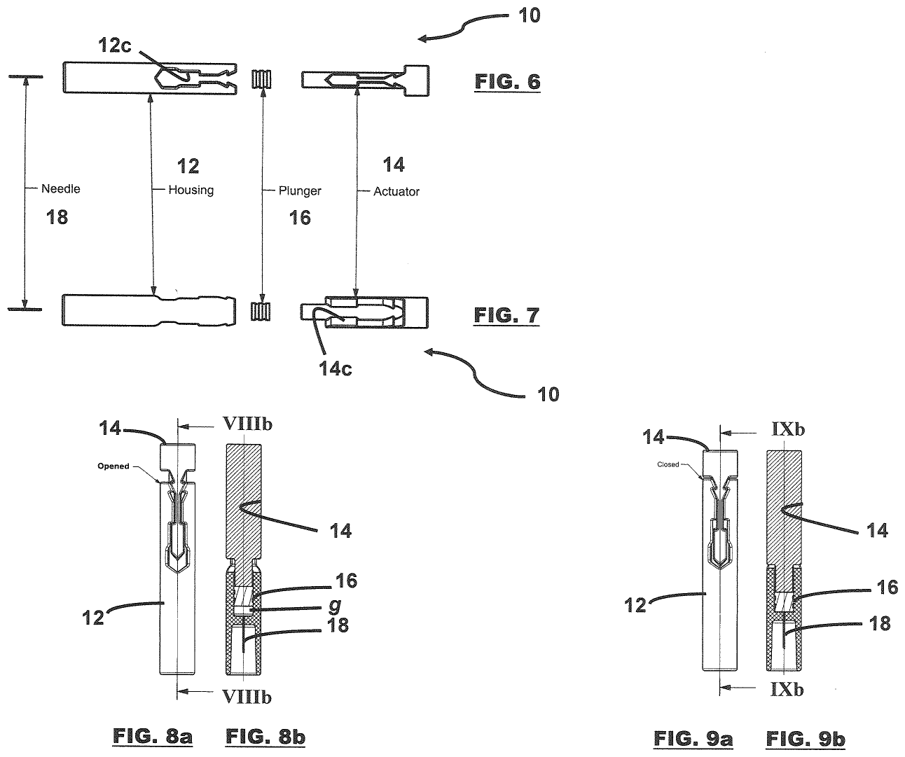

Consistent with illustrations, and specifically referring to FIG. 6 and FIG. 7, the housing 12 couples with the actuator 14, wherein the actuator 14 removably attaches with the housing 12 via friction fit. The housing 12 comprises an elongated and generally cylindrical body having a first end 12a and an opposing second end 12b. The first end 12a and second end 12b include cavities for receiving or accommodating insertable items, such as the actuator 14 for the first end 12a and a medicinal cartidge or carpule for the second end 12b. Approximately one half of the housing 12 body adjacent the first end 12a includes or comprises at least one surface gutter 12c, wherein one surface gutter 12c is disposed along a surface of the body, and alternatively, wherein multiple surface gutters 12c are disposed approximately along opposing surfaces of the body.

The actuator 14 comprises an elongated body having a substantially cylindrical core having a first end 14a and an opposing second end 14b. The core of actuator 14 body supporting at least one surface key 14c, wherein one surface key 14c is disposed upon the core, and alternatively, wherein multiple surface keys 14c are disposed approximately along opposing surfaces of the core. The actuator 14 includes a head at the first end 14a, wherein the head is provided for manipulating the actuator 14 within the housing 12 to deploy the plunger 16 and translate the needle 18 into a vessel.

The housing 12 and actuator 14 are mutually coupled with at least one surface gutter 12c receiving through sliding engagement and friction fit impingement a complementary at least one surface key 14c. In an alternative embodiment, consistent with FIG. 7, the housing 12 and actuator 14 are mutually coupled utilizing opposing surface gutters 12c as part of the housing 12 and opposing surface keys 14c as part of the actuator 14, wherein the opposing surface keys 14c slidingly engage via friction fit impingement within the complementary surface gutters 12c. In particular, such an embodiment may be described as a first surface gutter 12c receiving a first surface key 14c and a second surface gutter 12c receiving a second surface key 14c.

Consistent with FIGS. 8a, 8b, 9a, and 9b, the syringe 10 is depicted in opened (FIGS. 8a and 8b) and closed positions (FIGS. 9a and 9b). In the opened position, a gap (“g”) is provided between plunger 16 (depending from end of actuator 14) and needle 18 and the surface key(s) 14c are minimally inserted into surface gutter(s) 12c. In the closed position, the gap (“g”) is filled by the plunger 16 engaging the needle 18 and the surface key(s) 14c are maximally inserted into surface gutter(s) 12c.

In particular and depicted in FIG. 8a, in the opened position (non-deployment) of syringe 10 illustrates the mutual coupling of housing 12 and actuator 14, wherein the visible surface key 14c is partially or minimally inserted into surface gutter 12c. As particularly depicted the cross-sectional view of FIG. 8b, the actuator 14 and plunger 16 are in mutual communication, and the actuator 14 manipulates the plunger 16 though engagement with needle 18 had not yet been achieved. In FIG. 8b, a space or gap (“g”) between the plunger 16 and needle 18 is defined and is a non-visual indication of the opened position.

In particular and depicted in FIG. 9a, in the closed position (deployment) of syringe 10 illustrates the mutual coupling of housing 12 and actuator 14, wherein the visible surface key 14c is maximally inserted into surface gutter 12c. As particularly depicted the cross-sectional view of FIG. 9b, the actuator 14 and plunger 16 are in mutual communication, and the actuator 14 manipulates the plunger 16 into engagement with needled 18. In FIG. 8b, a space or gap (“g”) between the plunger 16 and needle 18 is filled and is a non-visual indication of the closed position.

Consistent with FIGS. 1-4, FIGS. 6-7, and FIGS. 8a-9b, the mutual coupling of surface gutter(s) 12c and surface key(s) 14c may be achieved in a variety of manners. As depicted, it is envisioned that the gutter(s) 12c and key(s) 14c have complementary shapes, although identical or mirror imaged shaping is not absolutely necessary. For example, in FIGS. 1, 2, 6, 7, 8a, and 9a, the surface gutter(s) 12c is/are depicted as including an enlarged chamber disposed at the end of an elongated channel and at least one conical pocket. Similarly, the surface key(s) 14c is/are depicted as including an enlarged bulb disposed at the end of an elongated stem and at least one conical barb. In another embodiment, the gutter(s) 12c and key(s) 14c include an additional conical pocket and corresponding conical barb. The gutter(s) 12c and key(s) 14c are comprised of or include returnably resilient material(s) so that the bulb(s) and/or barb(s) may penetrate the conical pocket(s) and stem(s) through temporary compression of the materials generated through force applied when coupled.

More particularly, advancing the actuator 14 from the opened to closed position advances the surface key(s) 14c maximally into the surface gutter(s) 12c, wherein the conical barb(s) advance into the conical pocket(s). After the key(s) 14c are maximally advanced into the surface gutter(s) 12c, the conical barb(s) is/are seated into the conical pocket(s) in a manner that generates an audible sound. In particular, the audible sound may resemble a click, pop, or other audible verification that the barb(s) have been seated within the pocket(s).

In use, the syringe 10 is designed to deliver small doses of a fluid or liquid concentrate to medical grade medicinal cartidge or medicinal cartidges or carpules, like those used to deliver anesthetic in general dentistry and medicine. The syringe 10 injects additive liquid into the medicinal cartidge or medicinal cartidges or carpules in a range from 0.03 to 0.15 mL. The syringe 10 comprises fluid or liquid such as sodium bicarbonate, or a similar fluid or liquid, to buffer or promote a neutral pH balance in the fluid or the liquid contained within the medical medicinal cartidge or carpule.

A system and/or method for using the syringe 10 may be utilized by the following steps:
1. Inserting the medicinal medicinal cartidge or carpule into the end of the syring 10 system with the needle 18 piercing the membrane of the medicinal cartidge or carpule;
2. Holding the medicinal cartidge or carpule in place, press the actuator 14 down on the syringe 10 system to inject the liquid in the system into the medicinal cartidge or carpule, pressing until a “click” occurs, ensuring the locking mechanism is engaged and all the liquid is out of the syringe 10; and,
3. Removing the medicinal cartidge or carpule from the syringe 10 and discarding the syringe 10 appropriately into a biohazard receptacle or container.

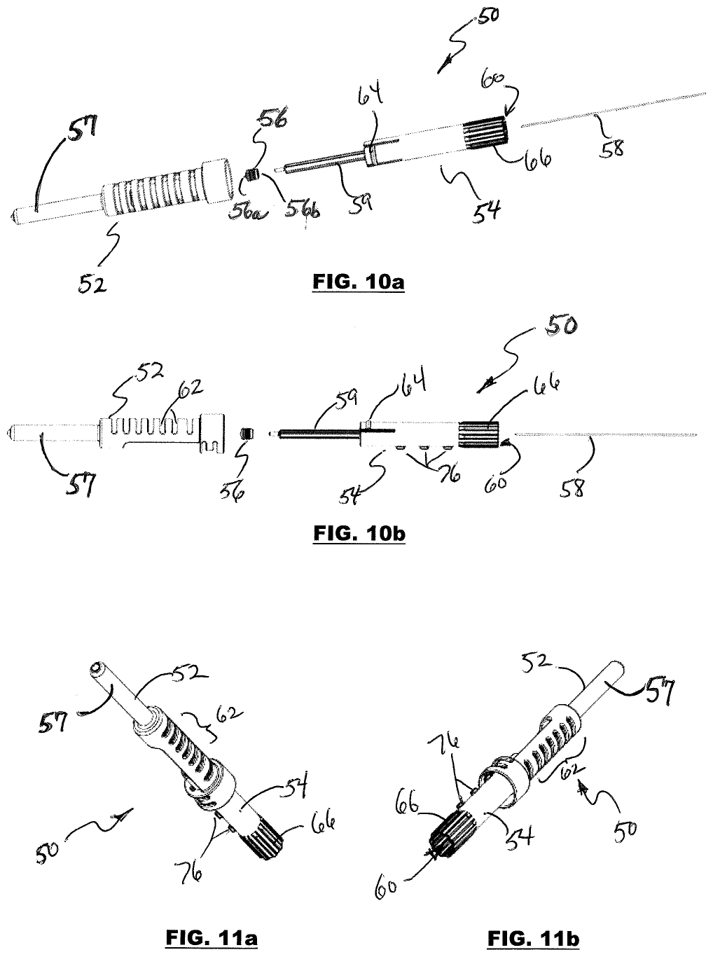

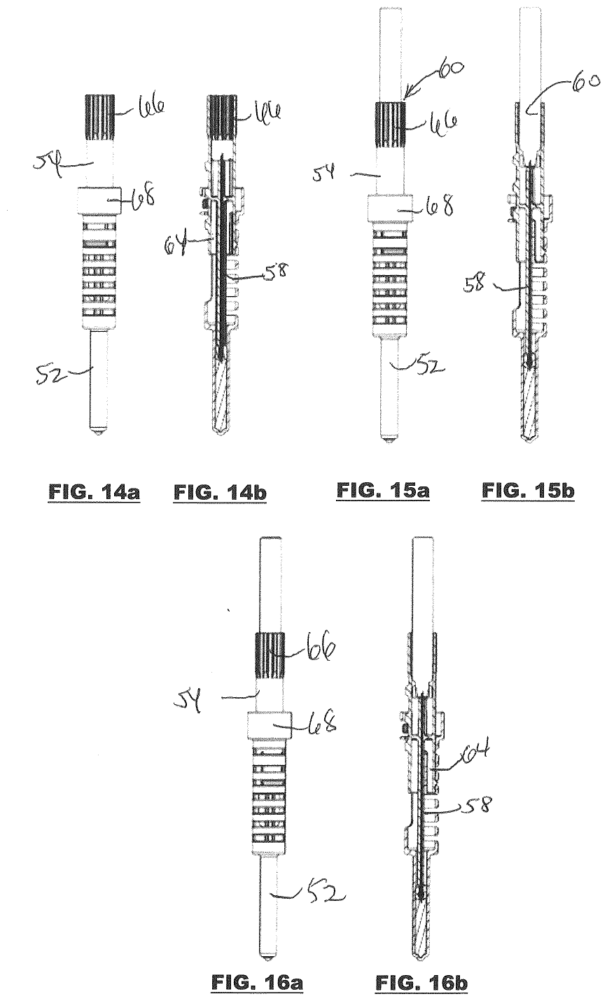

According to another embodiment, consistent with FIGS. 10a-16b, an additive syringe is described and disclosed and generally denoted by the reference character 50. The syringe 50 delivers small doses of a liquid concentrate to medical grade cartidges or carpules, like those used to deliver anesthetic in general dentistry and medicine. In particular, it is envisioned that the syringe 50 is suitably appropriate for medicinal cartridge/cartidges or carpules having a volume of approximately 1.7 mL to 1.8 mL, as well as the auto injector medicinal cartidge or medicinal cartidges or carpules possessing a volume of approximately 3.0 mL. The syringe 50 injects additive liquid such as sodium bicarbonate, or similar buffering agent to promote an optimal pH level. In a preferred embodiment, the volume of the additive liquid (e.g., buffering agent) may be provided in a range between 0.01 mL and 0.5 mL, often in a range between 0.01 mL and 1.0 mL, and most often in a quantity at or about 0.09 mL.

The syring 50 comprises a housing 52 and an actuator 54, the housing 52 accommodating the actuator 54 therein. The housing 52 and the actuator 54 are interoperative to access stored buffering agent from the housing 52 and deliver the buffering agent to a medicinal cartridge temporarily held by the actuator 54.

Internally, the housing 52 comprises a closed end and an open end, with the open end adjacent to the actuator 54 and adapted to accommodate the body of the actuator 54. The closed end is opposite the open end. The closed end has or includes a plunger 56. The plunger 56 includes a self-sealing vent or breach 56a at the terminus of a tunnel 56b. The plunger 56 and closed end of the housing 52 define a reservoir 57 therebetween that includes a quantity of buffering agent inserted therein during the assembly.

Internally, the actuator 54 comprises a needle 58 supported by chamber 59, the needle having an upper end and a lower end. The needle 58 via chamber 59 maintains a fixed orientation or position relative to the actuator 54. The lower end of the needle 58 mechanically communicates through the housing 52 by traversing the plunger 56 and accessing the buffering agent stored in the reservoir 57.

The needle 58 and the chamber 59 supporting the needle 58 are aligned with the plunger 56 and its vent/breach 56a and tunnel 56b so that the needle 58 traverses the vent/brach 56a and tunnel 56b and communicates with the quantity of buffering agent held in reservoir 57. The lower end of needle 58 draws a metered quantity of buffering agent from the reservoir 57. The needle 58 serves as a conduit for the metered quantity that is transported to the upper end of the needle 58 and delivered to the medicinal cartridge secured at the dock 60 at the end of the actuator 54.

Externally, the housing 52 has or includes a plurality of gutters 62 formed on the surface of housing 52. The gutters 62 are formed between portions of the body of the housing 52. Each gutter 62 forms a window or pocket between the body. Each gutter 62 is equidistantly spaced relative to an adjacent gutter 62. The housing 52 has or includes a collar 68 having a first wing 70 and a second wing 72, the first wing 70 and the second wing 72 havng a space 74 therebetween. Each wing 70, 72 is returnably resilient.

Externally, the actuator 54 has or includes a key 64 formed on the surface of actuator 54. The key 64 is formed as raised elements that is engageable with the gutters 62. The key 64 is returnably resilient. The actuator 54 also has or includes a dock 60 formed at an end opposite the end that engages with the housing 52. The dock 60 temporarily retains or supports a medicinal cartridge. The actuator 54 also has or includes a plurality of grips 66 adjacent dock 60. The grips 66 form an external circumferential surface ring about dock 60 for improved gripping and control of the actuator 54. The actuator 54 also has or includes a plurality of ridges 76. Each ridge 76 is equidistantly spaced relative to an adjacent ridge 76. Moreover, the ridges 76 are arranged or disposed in an alternating offset manner.

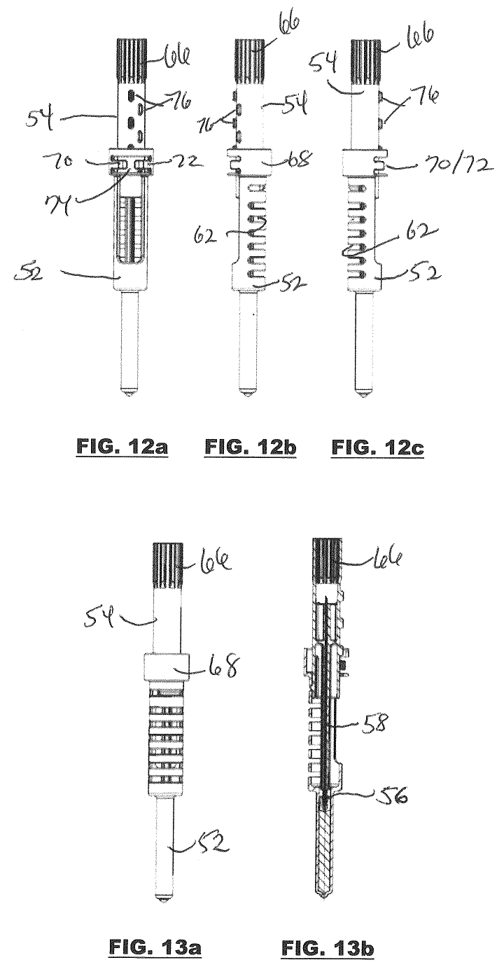

As best illustrated by FIGS. 12a through 16b, the orientation of the housing 52 and the actuator 54 when coupled orient the key 64 for engaging with one of the plurality of gutters 62 formed along the housing 52, and orient the ridges 74 for engaging with the wings 70 or 72 and the space 74. In particular, prior to administering the first quantity of buffering agent from the reservoir 57, the coupling of housing 52 and actuator 54 require positioning of the lowest ridge 76 (of the plurality) under the wing 70 or 72 and rotation of the lowest ridge 76 toward the space 74. Rotation of ridge 76 into space 74 causes the returnably resilient wing 70 or 72 to lift to release the ridge 76 to move into space 74 and generating an audible and tactile response. Advancing the actuator 54 into housing 52 then yields a defined displaced movement equal to the interval between the key 64 within gutter 62 and the next adjacent gutter 62. The returnably resilient key 64 and gutter 62 also yield or generate an audible and tactile response through that movement. The movement of key 64 from a resting gutter 62 position to a subjacent gutter 62 position causes a metered quantity of buffering agent to be drawn from the reservoir 57 and transported through the needle 58 and delivered to the opposing end of the needle 58 into the cartridge held in dock 60, thereby administering a defined and appropriate dosage of buffering agent to the material or agent in the cartridge.

In one embodiment, specifically as depicted in FIGS. 10a through 16b, the housing 52 comprises seven gutters 62 (and six ridges 76). The upper most gutter 62 (first position) is a charging or clearing position; the next five positions permit the individual administration of five separate distributions of buffering agent to five separate cartridges. The lowermost gutter (last or seventh position) is a stop or clearance position.

The orientation and arrangement of the embodiment illustrated in FIGS. 10a through 16b achieve several important improvements and features. In particular, the audible and tactile responsiveness of the syringe when advancing between positions allows the user to be confident that desired buffering administration is occurring. The orientation of the needle 58 to plunger 56, especially once a first quantity of buffering agent has been administered, maintains the needle 58 in a position that is exposed within the reservoir 57, maintaining sterility of the buffering agent and reducing the likelihood of coring (e.g., removal or erosion of material as debris into the buffering agent). Moreover, the upper end of the needle 58 (and the entirety of the needle 58 as a unit) are self-contained with the housing 52 and actuator 54, thereby reducing the likelihood of needle-induced injury(ies) and improving safety during usage. The grips 66 improve the likelihood of maintaining stability during usage.

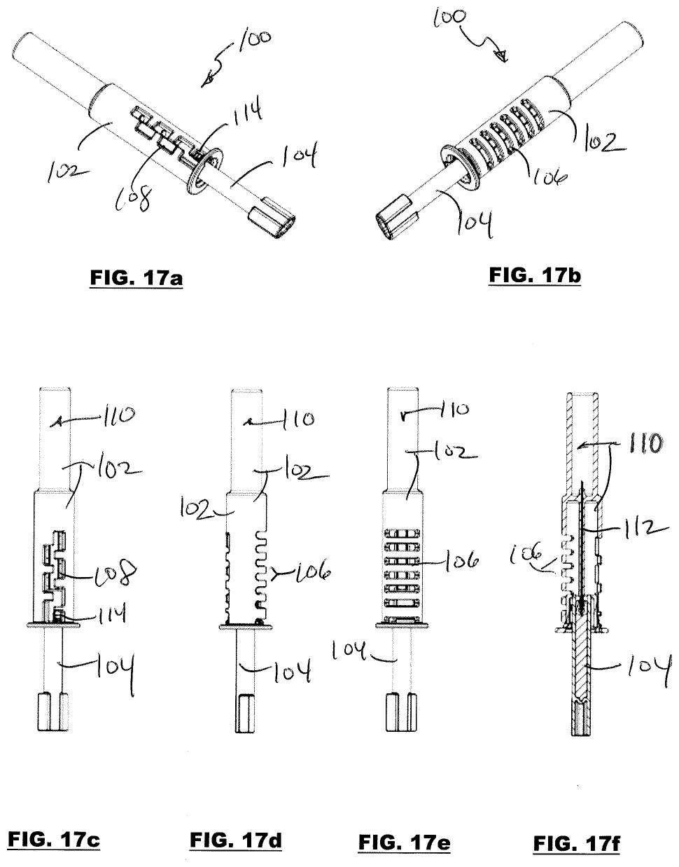

In another embodiment, consistent with FIGS. 17a through 17f, an additive syringe is describe and disclosed and generally dentoated by reference character 100. The syringe 50 delivers small doses of a liquid concentrate to medical grade cartidges or carpules, like those used to deliver anesthetic in general dentistry and medicine. In particular, it is envisioned that the syringe 100 is suitably appropriate for medicinal cartridge/cartidges or carpules having a volume of approximately 1.7 mL to 1.8 mL, as well as the auto injector medicinal cartidge or medicinal cartidges or carpules possessing a volume of approximately 3.0 mL. The syringe 100 injects additive liquid such as sodium bicarbonate, or similar buffering agent to promote an optimal pH level. In a preferred embodiment, the volume of the additive liquid (e.g., buffering agent) may be provided in a range between 0.01 mL and 0.5 mL, often in a range between 0.01 mL and 1.0 mL, and most often in a quantity at or about 0.09 mL.

The syring 100 comprises a housing 102 and an actuator 104, the housing 102 accommodating the actuator 104 therein. The housing 102 and the actuator 104 are interoperative to access stored buffering agent from the actuator 104 and deliver the buffering agent to a medicinal cartridge temporarily held by the housing 102.

The housing 102 has or includes a plurality of gutters 106 along one side and a plurality of switch-back stops or catches 108. The housing 102 has or includes an open end that engages or accommodates insertion of the actuator 104 therein. The housing 102 has or includes a dock 110 for temporarily holding or retaining a cartridge for administration of a metered quantity of buffering agent. The housing 102 has or includes a needle 112 supported therein and aligned to engage the cartridge as desired.

The actuator 104 comprises a stored quantity of buffering agent. The needle 112 at one end engages the stored buffering agent via a reservoir or other storage means and delivers to the opposing end into the cartridge the metered quantity of buffering agent. The actuator 104 has or includes a foot 114 that is used to navigate the switch-back stops or catches 108, wherein the foot 114 is stopped or caught by stops/catches 108 at each successive metered stage (e.g., at each switch-back). The actuator 104 is rotated between two vertically aligned orientations to navigate the foot 114 between successive or consecutive switch-backs.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

1. An additive syringe comprising:
a housing and an adjustable actuator, the housing and actuator mutually coupled, the housing having a surface gutter and the actuator having a surface key, wherein the surface key is positionable within the surface gutter, and the surface key and the surface gutter producing an audible and tactile response when the surface key is positioned within the surface gutter;
the housing having a larger diameter than the actuator, wherein the housing accommodates the actuator therein, and the housing having a plunger; the actuator having a needle supported by a chamber, the chamber aligning the needle with the plunger; and,
a dock formed in the housing or the actuator, the dock retaining a medicinal cartridge and aligning with the needle via the plunger to provide a metered quantity of buffering agent to the contents of the medicinal cartridge.

2. The additive syringe of claim 1, wherein the surface key is slidingly engaged with the surface gutter.

3. The additive syringe of claim 1, wherein the surface key is rotatably engaged with the surface gutter.

4. An additive syringe for delivering a metered dose of a buffering agent to a medicinal cartridge, the syringe comprising:
a housing configured to temporarily retain a medicinal cartridge;
a needle disposed within the housing and aligned for engagement with the medicinal cartridge;
an actuator operatively coupled to the housing, the actuator comprising a reservoir storing a quantity of buffering agent;
wherein the actuator includes a foot configured to engage a plurality of switch-back catches formed within the housing, such that incremental advancement of the actuator causes a metered amount of buffering agent to be delivered from the reservoir through the needle and into the medicinal cartridge; and,
wherein the actuator is manually rotatable between at least two positions to enable sequential engagement of the foot with the switch-back catches, thereby facilitating stepwise advancement and metered dosing.

5. The additive syringe of claim 1, wherein the medicinal cartridge has a volume of approximately 1.7 mL to 1.8 mL.

6. The additive syringe of claim 1, wherein the medicinal cartridge has a volume of approximately 3.0 mL.

7. The additive syringe of claim 1, wherein the metered amount of buffering agent delivered to the cartridge is in a range between 0.01 mL and 0.5 mL.

8. The additive syringe of claim 1, wherein the metered amount of buffering agent is approximately 0.09 mL.

9. The additive syringe of claim 1, wherein the buffering agent comprises sodium bicarbonate.

10. The additive syringe of claim 1, wherein the housing includes a plurality of longitudinal gutters aligned along a side of the housing.

11. The additive syringe of claim 1, wherein the dock for retaining the medicinal cartridge is integrally formed with the housing.

12. The additive syringe of claim 1, wherein the actuator is advanced in discrete steps by alternating rotation and axial movement to permit the foot to traverse successive switch-back catches.

13. The additive syringe of claim 12, wherein the foot engages one of the successive switch-back catches and produces an audible and tactile response.

14. The additive syringe of claim 1, wherein the actuator and the housing are constructed from medical-grade plastic materials suitable for sterilization.

15. A system for administering a buffered medicament, comprising:
an additive syringe comprising:
a tubular housing having an open proximal end and a dock at a distal end configured to temporarily retain a medicinal cartridge;
a plurality of switch-back catches disposed along an inner surface of the housing;
a needle fixed within the housing and aligned to engage a retained medicinal cartridge; and,
an actuator received within the proximal end of the housing, the actuator comprising a reservoir containing a buffering agent, a foot configured to sequentially engage the switch-back catches, the foot and switch-back catches producing an audible and tactile response, and a delivery pathway for transferring the buffering agent through the needle; and,
a medicinal cartridge retained in the dock of the housing, the medicinal cartridge having:
(i) a volume between approximately 1.7 mL and 3.0 mL; and,
(ii) a sealed chamber containing an anesthetic solution;
wherein actuation of the actuator in a sequence of rotation and axial advancement causes the delivery of a metered dose of the buffering agent into the chamber of the medicinal cartridge via the needle.

16. The system of claim 1, wherein the buffering agent comprises sodium bicarbonate.

17. The system of claim 1, wherein the actuator delivers a metered dose between 0.01 mL and 0.5 mL per advancement.

18. The system of claim 1, wherein the actuator is configured to deliver a total buffering volume of approximately 0.09 mL to the medicinal cartridge.

19. The system of claim 1, wherein the needle pierces a septum of the medicinal cartridge to establish fluid communication with the anesthetic solution,

20. The system of claim 1, wherein the dock is integrally formed with the housing and dimensioned to accommodate a standard dental or medical cartridge.

21. The system of claim 1, wherein the switch-back catches are arranged to permit one-way advancement of the actuator and prevent unintentional retraction.

22. A method for buffering a medicinal solution within a medicinal cartridge using an additive syringe, the method comprising the steps of:
(a) providing an additive syringe comprising:
(i) a housing having a cartridge dock and a plurality of switch-back catches;
(ii) a needle disposed within the housing and aligned for engagement with a cartridge retained in the dock; and
(iii) an actuator inserted into the housing, the actuator comprising a reservoir containing a buffering agent and a foot configured to engage the switch-back catches;
(b) inserting a medicinal cartridge containing a medicinal solution into the dock of the housing;
(c) actuating the actuator by rotating and axially advancing the actuator to sequentially engage the foot with the switch-back catches;
(d) delivering a metered quantity of the buffering agent from the reservoir through the needle and into the medicinal cartridge; and,
(e) mixing the buffering agent with the medicinal solution inside the medicinal cartridge.
